(19) United States
(12) Patent Application Publication
(10) Pub. No.: US 2005/0125292 A1
(43) Pub. Date: Jun. 9, 2005

(54) Retail rebate card

(76) Inventors: Jason Kassab, West Bloomfield, MI (US); Hadir Altoon, West Bloomfield, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/002,946

(22) Filed: Dec. 2, 2004

Related U.S. Application Data
(60) Provisional application No. 60/527,074, filed on Dec. 4, 2003.

(51) Int. Cl. G06F 17/60

(52) U.S. Cl. 705/14

(57) ABSTRACT

An improved method and apparatus for providing a customer rebate following purchase of a product includes an administrator receiving purchase data from the retailer, the administrator then claiming the manufacturer rebate from the manufacturer. The administrator provides an administrator rebate to finance the customer rebate, which is given to the customer before the customer leaves the retailer. The customer can then use the customer rebate to purchase other items at the store, allowing the customer to receive the customer rebate substantially at the time of purchase.

### REFERENCE TO RELATED APPLICATION

This application claims priority of U.S. Provisional Patent Application Ser. No. 60/527,074 filed Dec. 4, 2003, which is incorporated herein by reference.

### FIELD OF THE INVENTION

The invention relates to methods and apparatus for providing a customer rebate, in particular, a customer rebate at the time of purchase of a product.

### BACKGROUND OF THE INVENTION

Manufacturers of customer products such as appliances and electronic products frequently offer rebates to customers purchasing their products. In such a case the customer is given a form by the retailer for receiving the rebate. The customer fills out the rebate form, sends the form to the manufacturer, and eventually receives the rebate for the product. Because of the lag time from the time of purchase to receiving the rebate from the manufacturer, the customer cannot use the rebate for some time.

Further, in many cases, customers are not interested in filling out a paper form. The manufacturer fails to obtain desired information concerning the customer, and the customer will not feel goodwill towards the manufacturer. A customer may not take the rebate into account in the purchasing decision, aware that the trouble of claiming the rebate will be excessive. Accordingly, it would be advantageous for retailers and manufacturers to provide a customer rebate to the customer at the time and place of purchase.

### SUMMARY OF THE INVENTION

A method providing a customer rebate following purchase of a product includes an administrator receiving purchase data from the retailer, the administrator then claiming the manufacturer rebate from the manufacturer. The administrator provides an administrator rebate to finance the customer rebate, which is given to the customer before the customer leaves the retailer in the form of a prepaid cash card like a gift card which can be used at any merchant. The customer can then use the customer rebate to purchase other items at the store allowing the customer to receive the customer rebate substantially at the time of purchase.

The retailer transmits purchase data to the administrator, and receives an administrator rebate from the administrator substantially at the time of purchase. The retailer then can provide a rebate card to the customer, the rebate card allowing the customer to make an additional purchase at the retailer.

An apparatus for providing a customer rebate comprises a point-of-sale device operated by the retailer, the point-of-sale device including a data input mechanism and a card controller; and a data transceiver in communication with an administrator computer, the data input mechanism operable to receive purchase data, the purchase data including the product identity and the customer identity, the data transceiver transmitting the purchase data to the administrator computer. The card controller is used to provide the customer with a rebate card, and is further operable to allow the customer to purchase a second product using the rebate card.

### BRIEF DESCRIPTION OF THE DRAWINGS

FIG. 1 shows an improved system for providing a rebate to a customer;

FIG. 2 shows a further system for providing a rebate to a customer, the system including a plurality of retailers;

FIG. 3 shows a flowchart from the customer's viewpoint of an example method used to obtain a customer rebate;

FIG. 4 shows a flowchart from the administrator's viewpoint of an example customer rebate process; and

FIG. 5 shows a system in which data associated with a store loyalty card is provided to a manufacturer.

### DETAILED DESCRIPTION OF THE INVENTION

Apparatus and methods are described which allow a customer to receive a customer rebate at the place and time of purchase. The customer saves time through not having to fill out a paper claim form. The retailer may gain extra sale revenue from additional purchases funded by the customer rebate. Further, the manufacturer can obtain reliable customer data and provide an incentive for customers to purchase their product over another.

The rebate can be in the form of cash or a cash equivalent. In one example, the rebate is in the form of a rebate card provided to the customer by the retailer. The rebate card carries a credit which can then be used for additional purchases.

Examples of the present invention include an administrator. The administrator receives purchase data from the retailer, such as customer identity and product identity. The administrator provides a credit to the retailer, allowing the retailer to provide an instant rebate to the customer. The administrator then claims the manufacturer rebate from the manufacturer, standing in the shoes of the customer. The administrator may take a commission, and may finance the provision of the customer rebate following an assignment, by the customer, of the original manufacturer rebate to the administrator.

The rebate card can also be in the form of a credit card. The credit card can be issued by the administrator, the retailer, or other institution. Rebates can be credited to a rebate account associated with the card, or can be credited to any credit balance on the credit card. The customer can choose whether to use the rebate to reduce a credit card debt, or to leave any credit card debt unchanged and take an instant cash-equivalent rebate. Rebates can be credited to a separate rebate account, and be instantly available even if there is a credit card deficit. The rebate can be added to a card like a cash card or gift card which has a prepaid value and can be used at any merchant accepting the prepaid cash card (or PPCC). The amount can be added to by either getting another rebate or by purchasing additional value from a merchant in the prepaid card system.

In other examples of the present invention, the rebate card may accumulate points, for example in the form of incentive bonus points. These points may be exchanged for goods at participating retailers. The points may be accumulated instead of or in addition to cash rebates. For example, a customer may choose to accept a number of bonus points in place of a cash rebate, the number of bonus points being correlated with the value of the cash rebate.

A rebate card can also be in the form of a smart card. The rebate card can also include an identification of the customer, for example a name, an identity number, account number, other code, or other identifier, and be used to track purchasing patterns of the customer. The customer may receive additional rebates from the retailer based on purchases or combinations of purchases.

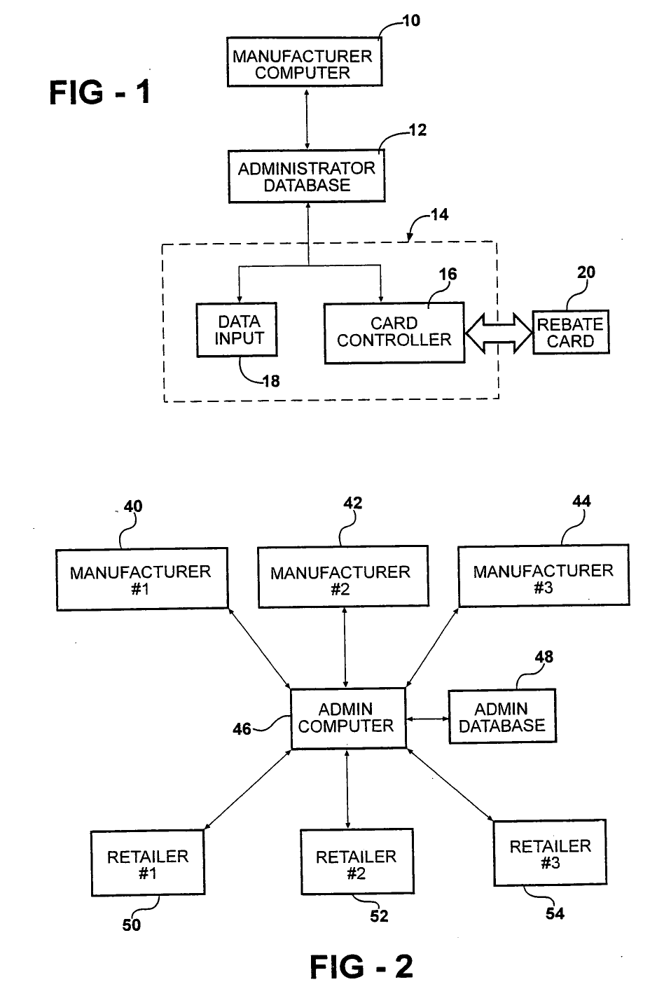

FIG. 1 shows an improved system for providing a customer rebate. The system comprises a manufacturer computer 10, administrator computer 12, point-of-sale device 14, the point-of-sale device including a data entry mechanism 18 and card controller 16, and rebate card 20. The administrator computer supports an administrator database.

The data entry mechanism 14 permits the retailer to input any desired information, such as customer data (such as customer identity), or any other purchase data. The system can be used to provide a rebate at the time and location of purchase, equivalent to an instant cash rebate. An example system includes a point-of-sale device linked to an in-store communications device which is connected to (or otherwise in communication with) the administrator computer.

As shown in FIG. 1, the system includes an administrator computer which is maintained by the administrator. The administrator computer is in electronic communication with each retailer (only one shown) in the system. Each retailer is provided with a data entry mechanism, for example an electronic interface which permits entering of information, such as purchase data, and a card controller.

The card controller is used to credit the rebate to the rebate card, and to read information provided by the card, for example information contained in a magnetic strip. The information can include whether the card is activated or not, and a balance which is the amount of rebates which have been credited to the card less any debits for purchases made with the card. The card may also store customer data, such as customer identity. Alternatively, the system can utilize a card which is read by a reader and permits a display of the customer's balance on a terminal screen.

When a product having an associated manufacturer rebate is purchased at a store, the rebate card is credited for the amount of the customer rebate by the retailer, and the rebate card given to the customer. The customer may sign or otherwise transfer rights (to the manufacturer rebate) to the administrator.

The data entry mechanism can include a numeric keypad, barcode scanner, alphanumeric keyboard, magnetic strip reader, RFID (radio frequency identification) reader, optical scanner, or other data entry device or combination of devices. Associated data processing may include decoding, optical character recognition, and the like.

In one example, upon obtaining information that a rebate is being offered, the administrator or the point-of-sale device prompts the retailer to enter purchase data, such as customer data (for example, customer identity) sufficient to enable the administrator to collect the manufacturer rebate from the manufacturer. Once the purchase data has been received by the administrator, the administrator then delivers the administrator rebate in the form of a credit which is applied directly to a rebate card or displayed as a credit on the screen.

Alternatively, the retailer identifies the product as being associated with a manufacturer rebate, collects desired purchase data, transmits the purchase data to the administrator, and receives an administrator rebate from the administrator. The retailer provides a customer rebate to the customer, for example as an instant cash rebate or equivalent.

The customer then is free to use the customer rebate, for example by purchasing other products from the original retailer or purchasing from another retailer in the system at a subsequent time. If value is added to a PPCC, the customer can use the PPCC anywhere the card is accepted and the retailer makes a commission off of processing.

For example, when a later purchase is made, the retailer selling the second product can swipe the rebate card through the card controller, including a card reader attached to an interface, enter the value of the purchase and, optionally, receive an approval code from the administrator.

An account containing a credit corresponding to the customer rebate may be stored on the administrator database, or by the retailer, or the value of the credit may be encoded in a data storage mechanism (such as a magnetic strip) on the rebate card.

After receiving administrator data from the administrator, including some or all of the customer data known to the administrator, the manufacturer provides a payment (a manufacture rebate) to the administrator and the administrator provides a payment (an administrator rebate) to the retailer. This system can be automated, and data transfer and rebates can be exchanged almost instantaneously. Alternatively, there may be a delay between transmitting the customer data to the manufacturer, and transmitting rebates back to the retailer. The administrator may provide a payment to the retailer or the customer before the manufacturer makes a payment to the administrator.

The administrator may open an account for each rebate card and obtain a manufacturer rebate from the manufacturer. The administrator can assign a value to the rebate by comparing the barcode information or other purchase data with the information stored in the CPU regarding the status of rebates offered by the manufacturer for that particular product.

Once an account is opened and a customer rebate paid to a customer, the administrator submits a claim to the manufacturer. The claim submission includes the submission of administrator data to the manufacturer, for example including purchase data provided by the retailer. The administrator will have previously entered into a relationship with the manufacturer permitting the administrator to submit rebate claims on behalf of individual customers. The administrator then awaits payment of the manufacturer rebate. Payment time may have been previously agreed to between the administrator and the manufacturer. Accordingly, the administrator may finance the customer rebate in the interim, by providing an administrator rebate to the retailer before receiving the manufacturer rebate.

In one example, after the purchase transaction is complete, the administrator forwards payment to the retailer in the form of an administrator rebate, for example in the same way a credit card company could forward payment to the retailer.

Thus disclosed is a novel system for providing a rebate to a customer, which can be an instant rebate. The system permits increased sales for a retailer because the customer has more cash, or a cash equivalent, on hand to spend while still in the retailer's store or have a PPCC.

The system of FIG. 1 shows only one manufacturer and a single point-of-sale device. However, the system can be expanded so as to include a plurality of manufacturers, and a plurality of point-of-sale devices which may be associated with one or more retailers.

FIG. 2 shows a system including a plurality of manufacturers, such as first manufacturer 40, second manufacturer 42, third manufacturer 44; an administrator computer 46 connected to an administrator database 48; and a plurality of retailers such as first retailer 50, second retailer 52, and third retailer 54. Purchase data collected from any retailer can be stored in the administrator database 48. Hence, when a purchase is made by an identified customer, purchase data including stored data on database 48 can be passed to the manufacturer of the purchased product.

In this way, the manufacturer obtains extensive customer data, such as previous purchase information and optionally demographic data relating to the customer. The customer data may match that provided by the normal mail-in card, and may be more accurate.

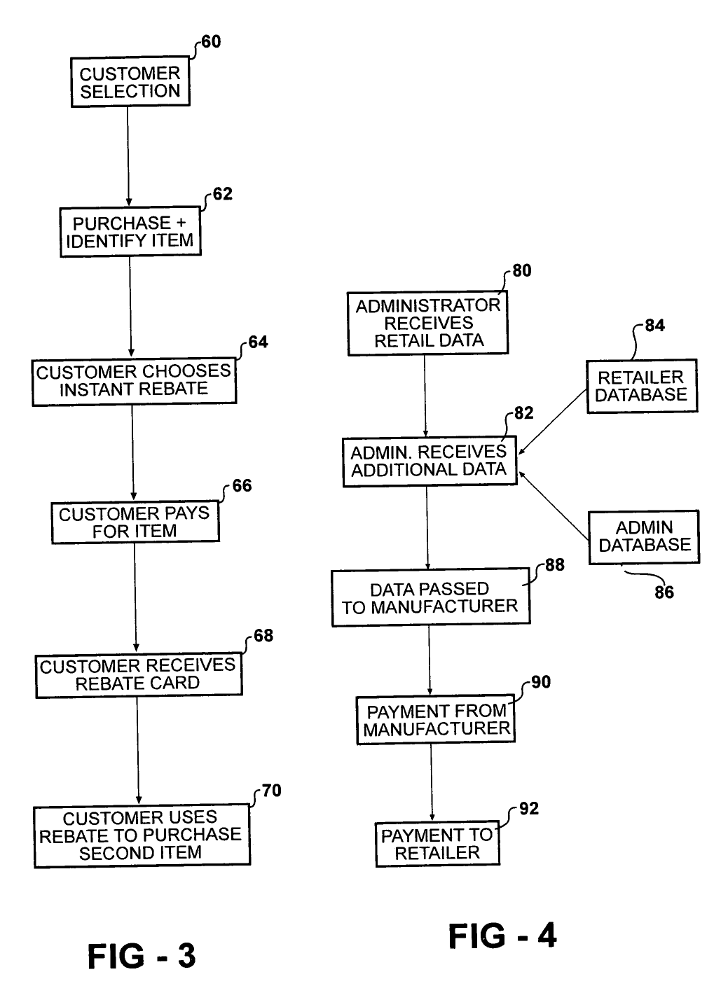

FIG. 3 is a flowchart showing a method of providing a rebate, for example an instant rebate, from the viewpoint of a customer. Box 60 corresponds to a customer selecting a product for which a rebate is possible. Box 62 corresponds to the customer taking the product to a point-of-sale within a retail store, the retailer then identifying the product as one associated with a manufacturer rebate. Box 64 corresponds to the customer choosing to take an instant rebate, and so giving up the right to a paper-based rebate obtained through the mail. This corresponds to the customer assigning the right to the manufacturer rebate to the administrator. Box 66 corresponds to the customer paying for the purchased product. Box 68 corresponds to the customer obtaining a rebate, for example through a rebate card issued by the store. Box 70 corresponds to the customer purchasing a second product at the store using the rebate.

The customer need not be aware of processes in the background, such as the purchase data being provided to the administrator, and the administrator financing the customer rebate. Hence, this method provides a very simple way for a customer to obtain a customer rebate.

FIG. 4 shows a method of providing a rebate from the viewpoint of the administrator. Box 80 corresponds to the administrator receiving purchase data from the retailer. Box 82 corresponds to the administrator receiving any additional purchase data from the retailer, such as customer data associated with a loyalty program. Box 84 corresponds to the store providing additional customer data from its own database, for example from customer data provided by the customer in relation to a loyalty program. Box 86 corresponds to the retrieval of any additional data related to the customer from the administrator database, or other database. Box 88 corresponds to the administrator passing administrator data (for example, some or all of the purchase data along with any other data) to the manufacturer. Box 90 corresponds to the manufacturer providing a payment (the manufacturer rebate) to the administrator. Box 92 corresponds to the administrator providing a payment (the administrator rebate) to the retailer.

The steps described above may be performed in a different order. In particular, the steps corresponding to Boxes 90 and 92 may occur in any time order, or substantially simultaneously.

Loyalty Card

Many stores operate a loyalty program. In a typical loyalty program, a customer receives a loyalty card, which identifies the customer and entitles the customer to a purchase discount. The customer may provide customer data, such as name, social security number, address, and the like, to obtain the loyalty card. The retailer then can track every purchase made by the customer at the store. These previous purchases provide insight into the customer's interests, buying habits, and the like. The loyalty card may also be used as a rebate card according to the present invention.

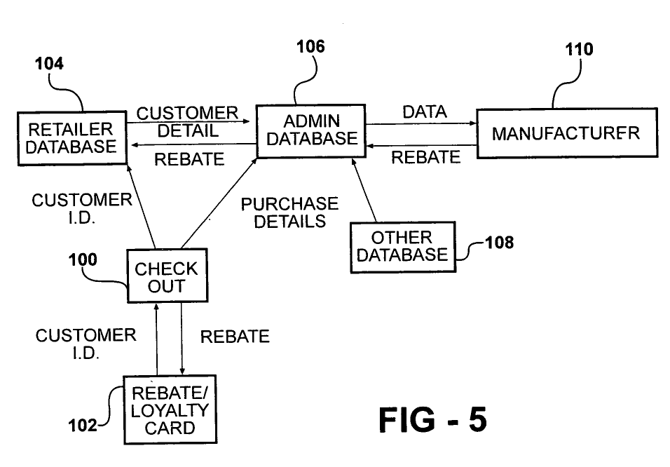

FIG. 5 shows a system including the use of loyalty card data. The system includes a point-of-sale device 100, customer rebate card 102, store database 104, administrator database 106, additional customer information database 108, and manufacturer service system 110. At the time of purchase, the customer provides a loyalty card to the checkout person. The loyalty card is used to identify the customer, and retrieve customer data from the store database 104. The additional customer data provided by use of a loyalty card may include any information that the customer provided when applying for the loyalty card, and also additional purchasing patterns associated with the customer. Some or all of this data is provided to the administrator database 106.

The loyalty card provides a unique identity for a particular customer. Hence, having the customer identity, additional customer data can be retrieved from the administrator database, the retailer, other retailers, and also from other sources, such as financial databases and credit agencies.

The administrator may store a copy of loyalty card related data received from the store, and add this additional customer data to existing customer data. The enhanced customer data can then be provided to the manufacturer if the customer purchases a product under this scheme from another retailer.

Customer Rebate

The customer rebate may be in the form of a rebate card, a printed check, a money order, a credit to an account used to purchase the product (such a credit card account or bank account), a discount applied to the purchase price of the product, a coupon allowing further purchases up to a certain value, a discount coupon, credit to a PayPal™ account, PPCC or similar web-based account, travelers check, air miles, cash, check, or other form of financial instrument, credit, or discount.

In other examples, the rebate can be provided to the customer in the form of a gift card of predetermined value, coupon printed at the time and place of purchase (such as a receipt having a receipt barcode, the receipt barcode authorizing a credit), a preprinted coupon or voucher, credit to a bank account or credit account of the customer, credit to a store account, credit to a gas purchase credit account or other store account, a customer product having a value perceived by the customer as related to the value of the credit, or through some other mechanism. In other examples, the customer rebate can be automatically mailed to the customer at their address.

The value of the rebate may be advertised with the product. A customer may select an additional product or products up to the rebate value and receive the additional product free when purchasing the product having an associated rebate.

Through a purchase transaction, the customer may incur a credit card debt which will come due at a future time. Of course, the customer may also pay by debit card or cash or any other method that the customer prefers. However, regardless of any future credit debt, the customer can obtain a rebate which may be the equivalent of cash. For example, the customer may take the rebate card and use a cash equivalent on the rebate card to purchase another product at the retailer. The customer may also take the rebate card and use it for purchase at another retailer. A number of retailers may be associated through accepting each other's rebate cards or there can be one universal update card which is used as a PPCC.

The rebate can be used in the same store immediately after the time of purchase, or at the same store within some future defined time period, or within a different store (for example another participating retailer) with or without any time restrictions.

In other examples, the customer rebate may take the form of a credit, or a credit only received after the manufacturer provides a payment to the administrator, or a credit only received after the administrator provides a payment to a retailer.

The customer rebate may be provided to the customer substantially at the time of purchase, that is during the purchase transaction, before the customer leaves the point-of-sale equipment, or otherwise before the customer leaves the retail store. For example, the customer may pick up a rebate card at a service desk or otherwise within the retail store. The customer rebate can be provided to the customer within one minute of completion of the purchase transaction.

Rebate Card

In examples of this invention, the retailer provides a rebate card at the time of purchase. Alternatively, if the customer already has a card, the retailer applies a rebate in the form of data or account information to the card.

For example, the customer makes a purchase and would be entitled to a $100 mail-in rebate associated with the purchase. The customer can decide to take a rebate instantaneously. The retailer provides a rebate card or PPCC, which can then be used by the customer to make additional purchases from the retailer. In this method, the retailer or the administrator may choose to finance a rebate to the customer, while waiting for a payment from the manufacturer.

The customer can receive the rebate card at the time and place of purchase. The customer can then use the rebate card immediately to purchase goods, or the customer may hold on to the rebate card for use at a subsequent time. The value of any later purchase can be deducted from the amount credited to the rebate card. Additional rebates associated with additional products purchased either at the originating store or at other stores can be added to the rebate card.

In one example, the customer purchases a product at a certain retailer. The product can be advertised as being with a rebate, or more particularly as being with an instant rebate. The customer takes the product to a point-of-sale device such as a cash register. The retailer identifies the product, for example through a barcode scan, swipe of a magnetic strip, or any other appropriate method. Using the determined UPC (Universal Product Code) or other identifying data, the product is recognized as one having an associated rebate. The customer purchases the product in a normal manner, for example by providing a credit card which is charged with the full non-rebated price of the product. The customer receives a rebate card. The rebate card carries a credit, for example through data stored on a magnetic strip, chip, or other data storage mechanism on the rebate card, or through an account, the account number being identified by the rebate card.

Alternatively, the customer may already be carrying a rebate card. The customer provides the rebate card to the retailer at the time of purchase, and the rebate is added to the card or corresponding account as appropriate.

The amount of a later purchase made using the customer rebate can be debited from the rebate card (equivalently, from an associated account) and a new balance imprinted on the magnetic strip or other data storage mechanism on the rebate card.

In a similar way, if the customer purchases additional goods having associated manufacturer rebates, the additional customer rebates can be added to the balance on the rebate card. The balance on a rebate card can be displayed on a monitor of a point-of-sale device.

The customer cannot return the original product purchased without forfeiting the customer rebate. If the amount left on the rebate card is less than the rebate which was granted for the product, it cannot be returned unless the customer refunds the difference. Any exchanges may be made in accordance with conventional store guidelines.

The rebate card may also function as a loyalty card, for example providing a discount for the customer at the retailer.

Credit Card as Rebate Card

If a credit card or similar is used as a rebate card, there can be a two-tier financial system associated with the card. The card may have a credit balance, payable when due according to some predetermined billing cycle. The card may have a separate rebate balance which can be spent freely or subject to any minor restrictions. In this system the customer gets the use of a rebate immediately, even if they are carrying a credit balance.

If the customer credit balance exceeds a certain value, the rebate may not be accessible, and may be applied immediately to the credit balance. It may be necessary to remove an incentive for the customer to make large credit payments in order to obtain small cash equivalent rebates.

In one example, conventional equipment can be used to provide a credit on the rebate card, in the same way the credit can be provided on a customer's credit card. The information that the customer provides when applying for the credit card (with rebate card function) can be provided to the manufacturer when a rebate is given to the customer. The rebate can be applied to any balance on the card, or may be provided as a separate cash equivalent which can be accessed instantly.

Rebate Card Provided by Administrator

In other examples according to the present invention, the rebate card is provided by the administrator of the rebate system. Participating retailers recognize the card, and provide an instant credit when a customer purchases from that retailer. Hence, the administrator-provided rebate card provides an incentive to the customer to shop at participating retailers.

Customer data provided by the customer to obtain the rebate card can be stored in the administrator database, and provided to the manufacturer.

In some examples, the rebate card can be in the form of a credit card issued by the administrator. The rebate card may also permit the customer to obtain a discount on most purchases, in the form of a loyalty card.

Out of Store Rebate Card

In one example, the customer makes a purchase at a first retailer and receives a customer rebate. However, the customer may decide that they do not want to spend the customer rebate at the first retailer. The customer can take the rebate card to a second retailer, where it may be used as a cash equivalent. A multi-retailer rebate card may be replenished or added to at any retailer or service provider associated with the administrator.

For example, a customer may obtain cumulative rebates from a number of retailers, or may also receive rebates added to the same card through use of associated credit cards, cell phones, airline ticket purchases, online purchases, or any other purchase through an associated company. The customer can accumulate the rebates and use that cash equivalent to make purchases, either through associated retailers, or through websites, or through any other method.

Restrictions on Use of Customer Rebate

There need be no restrictions on the use of the customer rebate. However, in some examples, time restrictions may be applied. For example, a retailer may want a customer to return during a weekday evening.

There may be further restrictions on the use of the rebates, for example that the rebate be used towards a maximum percentage discount on any other purchase. For example, if a maximum of 10% discounts is allowed, a $10 rebate could only be used on a purchase of $100 or more. Other percentage discounts may be allowed, such as 20% or 50%. The rebate may also be restricted to purchases over a certain value, for example over $10.

Purchase Data

The retailer provides purchase data to the administrator. In general, purchase data provided by the retailer to the administrator can include customer data, an assignment by the customer of the manufacturer rebate to a third party (such as the administrator, or alternatively, the retailer), and purchase data (such as time and location of purchase, product identity, price paid for the product, and the like).

The purchase data may further include product identity, such as a barcode, serial number, or other product identifier (or information derived therefrom) relating to the product purchased, which permits the administrator to know the manufacturer and product model number of the product being purchased. Purchase data may include the purchase price, date and time of purchase, model number of the product, the product identity, purchase location, serial number, and customer data such as the customer's identity.

Purchase data can be inputted into a point-of-sale device, or otherwise determined during the purchase process, for example through an automated process. Purchase data can be inputted or otherwise received through a data entry mechanism associated with a point-of-sale device, and provided to the administrator.

Purchase data may include a product identity number (such as a serial number) that must be provided in order to get a rebate. The customer may not then use the same product ID to claim a rebate through any conventional mail-based system.

The purchase data may also include customer data. Customer data may include customer identity, social security number, drivers license information, credit card number, magazine subscriptions, future purchase plans, automobile ownership details, credit rating, financial records, e-mail address, other data, and the like.

Customer data may include demographic data such as gender, age (or age range in which the customer falls), income (or income band), education level, zip code, full address, existence and number of children, child age, child gender, parental information, residence information such as rental or owner-occupier, hobbies and interests, and the like.

Customer data may further include other information related to the customer such as that provided to the retailer at the time of purchase or in relation to other interactions between the retailer and the customer, other purchases made by the customer, and the like, or other identifying or demographic information.

Customer data may also include data provided by the customer to the retailer (or other entity) at an earlier time, for example through a customer loyalty program. Alternatively, the customer may be asked to provide demographic data at the time of purchase. The customer may recognize the value of trading personal data in order to obtain a rebate card.

Customer data may include a unique identifying code assigned by the administrator, or by the retailer. The true customer identity corresponding to the code need not be provided to other parties.

Additional customer data obtained using the customer identity may include purchasing patterns from other retailers, information from credit agencies, banks, mortgage companies, other retailers, and any other source. Some or all of this information can be provided to the manufacturer.

Hence, the manufacturer obtains possibly more and almost certainly more reliable customer data. There is a strong incentive for the manufacturer to use a rebate system according to the present invention over a conventional system wherein the customer fills out a paper card. While filling out a paper card, the customer may omit or provide incorrect information.

Customer data may also be obtained from the credit card issuer used to make the purchase, or from a loyalty card account associated with a customer. It may be necessary to obtain customer consent for extensive customer data to be provided to the manufacturer. However, the customer presumably would be happy to enable this in order to obtain a commission. Alternatively, customer data may be provided anonymously to the administrator and/or manufacturer.

Administrator Data

The administrator provides administrator data to the manufacturer, which may include some or all of purchase data provided by the retailer. The administrator may augment the data with additional customer data that the administrator may have previously obtained, or can obtain from another source.

The administrator data may include all the purchase data received from the retailer, or a subset thereof. The administrator data may comprise at least part of the purchase data augmented with other data related to the customer. For example, additional customer data may be stored in an administrator database. Purchase data may also be stored by the administrator database.

For example, the administrator may provide the manufacturer with demographic data related to the customer, and previous purchases by the customer. The customer identity can be used by the administrator to obtain other customer data, for example relating to previous purchases by the customer. However, the customer identity need not be provided to the manufacturer as part of the administrator data.

Manufacturer Rebate

In examples of the present invention, the manufacturer rebate is provided by the manufacturer to the administrator. The manufacturer rebate may be greater than the customer rebate received by the customer, the difference being used to provide a commission to the administrator. The manufacturer rebate may also be enhanced to reflect the added value of accurate customer data within the administrator data provided by the administrator to the manufacturer. For example, if detailed purchase data is provided, for example including social security number, or predetermined types of data are received, the manufacturer rebate can be enhanced. The administrator may keep the difference between the enhanced manufacturer rebate and the actual customer rebate.

The retailer may make up any commission paid to the administrator, so that the customer rebate is the same as the administrator rebate.

Administrator Rebate

The administrator rebate is provided by the administrator to the retailer. The administrator rebate can be provided substantially instantaneously, or at some time before the administrator receives the manufacturer rebate, so as to allow the customer rebate to be provided to the customer substantially at the time of purchase, that is, before the customer has left the retailer after completing the transaction.

The administrator rebate may be provided to a central retailer computer, which then sends an authorization to the point-of-sale device to provide the customer rebate.

The customer rebate may be applied to a rebate card directly by the administrator, for example using the point-of-sale device provided by the retailer. The administrator may set up an account associated with the rebate card, and modify data stored on the rebate card to reflect the credit balance. In this way, the retailer does not provide a customer rebate out of its own funds, and the administrator rebate becomes the customer rebate.

Alternatively, the administrator provides an administrator rebate to the retailer, and the retailer provides the customer rebate to the customer.

Commissions

The administrator may choose to retain a commission for funding a rebate to a customer. However, the retailer may choose to make up the difference between the amount the retailer receives from the administrator and the stated value of the rebate. This provides additional goodwill from the customer. Alternatively, the customer may choose to pay a small commission in order to obtain a rebate. The commission may ultimately be retained by the administrator. Alternatively, any commission payable to the administrator may be funded by the credit card used in the purchase.

The retailer may be assessed a transaction fee (equivalently, administrator commission), which can be a percentage of the purchase value. The transaction fee can be in the range of 1-10%, such as 2%, 3%, 4%, or 5%, and the balance forwarded to the retailer.

Other Examples

Hence, an apparatus for facilitating provision of a customer rebate to a customer (the customer purchasing a product from a retailer in a purchase transaction having a time of purchase, the product being manufactured by a manufacturer and associated with a manufacturer rebate) comprises a point-of-sale device operated by the retailer, an administrator computer, a first communications link between the point-of-sale device and the administrator computer, a manufacturer computer, and a second communications link between the administrator computer and the manufacturer computer. The point-of-sale device is operable to process the purchase transaction, transmit purchase data to the administrator computer, the purchase data including a product identification, to receive an administrator rebate from the administrator computer, and to provide a customer rebate to the customer. The administrator computer is operable to receive purchase data from the retailer, transmit administrator data to the manufacturer, receive a manufacturer rebate from the manufacturer, and to transmit an administrator rebate to the retailer. The manufacturer computer is operable to receive the administrator data from the administrator, and to transmit the manufacturer rebate to the administrator.

Transmission of the administrator rebate and/or manufacturer rebate may comprise an electronic fund transfer. The point-of-sale device may provide a rebate card to the customer substantially at the time of purchase, for example by writing data to a magnetic strip on a plastic card.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Patents or publications mentioned in this specification are incorporated herein by reference to the same extent as if each individual publication was specifically and individually indicated to be incorporated by reference. In particular, U.S. Prov. Pat. App. Ser. No. 60/527,074 filed Dec. 4, 2003, is incorporated herein in its entirety.

1. A method of providing a customer rebate to a customer, the customer purchasing a product from a retailer in a purchase transaction having a time of purchase and a purchase location, the product being manufactured by a manufacturer and associated with a manufacturer rebate, the method being carried out by an administrator, the method comprising the steps of:
receiving purchase data from the retailer, the purchase data including a product identity;
claiming the manufacturer rebate from the manufacturer; and
providing an administrator rebate, the administrator rebate being used to finance the customer rebate to the customer.

2. The method of claim 1, wherein the administrator rebate is provided to customer at the purchase location and substantially at the time of purchase.

3. The method of claim 1, wherein the administrator rebate is provided to the retailer, and the customer rebate is provided by the retailer to the customer at the purchase location and substantially at the time of purchase.

4. The method of claim 1, further comprising receiving an assignment of the manufacturer rebate from the customer.

5. The method of claim 1, wherein the administrator rebate is provided before the manufacturer rebate is received from the manufacturer.

6. The method of claim 1, wherein the administrator rebate is less than the manufacturer rebate, so as to provide a commission to the administrator.

7. The method of claim 1, further comprising providing administrator data to the manufacturer, the administrator data including the product identity.

8. The method of claim 7, wherein the administrator data further includes a customer identity.

9. The method of claim 7, wherein the administrator data further includes additional customer data provided by the customer.

10. The method of claim 9, wherein the additional customer data arises from a customer loyalty program.

11. The method of claim 7, wherein the administrator data further includes demographic information related to the customer, the demographic information including approximate customer age and customer gender.

12. The method of claim 7, wherein the administrator data further includes customer data retrieved from an administrator database.

13. The method of claim 7, wherein the administrator data further includes information related to previous purchases by the customer.

14. The method of claim 1, wherein the customer rebate is provided to the customer in the form of a rebate card.

15. The method of claim 1, wherein the customer rebate is provided to the customer in the form of a rebate to an account.

16. The method of claim 1, wherein the customer rebate is provided to the customer in the form of a printed coupon.

17. A method of providing a customer rebate to a customer, the customer purchasing a product from a retailer in a purchase transaction having a time of purchase and a purchase location, the product being manufactured by a manufacturer and associated with a manufacturer rebate, the method comprising the steps of:
transmitting purchase data to an administrator, the purchase data including a product identity;
receiving an administrator rebate from the administrator substantially at the time of purchase; and
providing a rebate card to the customer, the rebate card allowing the customer to make an additional purchase at the retailer, the rebate card providing the customer rebate.

18. The method of claim 17, further comprising obtaining customer data from the customer at the time of purchase, the customer data being transmitted to the administrator.

19. The method of claim 17, wherein the customer data includes a customer identity.

20. The method of claim 17, wherein the rebate card is provided to the customer before the customer leaves the retailer.

21. The method of claim 17, further comprising transmitting a customer assignment of the manufacturer rebate to the administrator.

22. An apparatus for providing a customer rebate to a customer, the customer having a customer identity, the customer purchasing a product from a retailer in a purchase transaction, the product being manufactured by a manufacturer and associated with a manufacturer rebate, the customer rebate being financed by an administrator having an administrator computer, the apparatus comprising:
a data input mechanism receiving purchase data related to the purchase transaction, the purchase data including the product identity;
a data transceiver in communication with the administrator computer, receiving purchase data from the data input mechanism, transmitting the purchase data to the administrator computer, and receiving a rebate authorization from the administrator computer; and
a card controller, receiving a rebate authorization signal from the data transceiver, and providing the customer with a rebate card, the rebate card providing the customer rebate.

23. The apparatus of claim 22, wherein the card controller is further operable to allow the customer to purchase a second product using the rebate card.

24. The apparatus of claim 22, wherein the purchase data further includes the customer identity and a customer assignment of the manufacturer rebate to the administrator.
